(19) United States
(12) Patent Application Publication
(10) Pub. No.: US 2013/0014485 A1
(43) Pub. Date: Jan. 17, 2013

(54) Apparatus for propulsion

(71) Applicant: Peter Hoang Nguyen, Sacramento, CA (US)

(72) Inventor: Peter Hoang Nguyen, Sacramento, CA (US)

(73) Assignee: Peter Hoang Nguyen, Sacramento, CA (US)

(21) Appl. No.: 13/184,559

(22) Filed: Jul. 17, 2011

(51) Int. Cl. F02K 9/68

(52) U.S. Cl. 60/200.1

(57) ABSTRACT

An apparatus for propulsion includes a main body, a fluid flow channel for fluid mass to circulate within a self-sealed apparatus, an air flow channel for air to circulate within a self-sealed apparatus and/or to the open environment, a fluid mass, a rotator having compartments to move the fluid mass centrifugally, a cover providing sealed containment for the apparatus and providing the means to remove the rotator from the main body, and a rotator shaft providing rotation to the rotator by motor. A preferred embodiment includes an apparatus with two or more fluid flow channels for fluid mass to circulate within a self-sealed apparatus. Another preferred embodiment includes an apparatus with two or more air flow channels for air to circulate within a self-sealed apparatus and/or to the open environment. And another preferred embodiment includes the main body that can be manufactured in one or more parts.

### BACKGROUND OF THE INVENTION

This invention relates generally to the field of transportation and more specifically to an apparatus for propulsion.

There are different modes of transportation for different environments. On land, any vehicle that has wheels is the main type of transportation. In the air, any vehicle that has wings to provide lift is the main type of transportation. In space, any vehicle capable of discharging mass is the main type of transportation.

An automobile requires a transmission between the engine and the tires to provide the necessary rotational force to turn the tires in order to provide movement forward or backward depending on the gear selected. The addition of the transmission adds extra weight to the car and loss of engine power through the transmission gears. An airplane requires the movement of air over and under the wings of the airplane to provide both the necessary lift and forward movement by pushing air rearward. This limits the ability of the plane to go into space, where there is no air to provide the lift and the thrust of air necessary to push the plane forward. A rocket requires expulsion of mass to move the rocket forward; and this expulsion will generate a great amount of thrust to move the rocket forward. The thrust is limited, however, by the amount of fuel that the rocket carries, which fuel also adds to the weight of the whole rocket. And because the rocket exhausts the fuel supply, there is a limit to its speed.

In contrast to rocket, airplane, boat and automobile, the present invention uses the rotation of fluid mass to create an imbalanced centripetal force which results in a directional force. This invention, however, does not require expellants, as rockets do, but rather circulates the fluid mass that it uses to provide the directional force over and over again. The present invention would be able to provide a continuous directional force applied to the desired direction. Since the present invention does not interact with its surrounding environment to provide the necessary force to move vehicle, the same vehicle can be used on land or in water, air, and space without any modification. Furthermore, the vehicle can simultaneously maneuver in three dimensions by using one or more apparatuses at the same time.

This invention is lightweight, especially compared to rockets, because the necessary thrust is self-contained and repeated and reused. This invention would benefit outer-space travel as much as on-earth travel due to its compactness and usefulness.

Some prior technologies have a counter-force associated, so they are unable to convert most of the mass into useable force. U.S. Pat. No. 6,109,123 (FIG. 4) proposes the use of solenoids to change the radius of the rotating weights and thereby create a net resultant force. U.S. Pat. Application Publication No. US 2009/0165594 A1 (FIG. 1) proposes a fluid rotation within an annular tubular container that creates a net resultant force by varying the diameter of the annular tubular containers. U.S. Pat. No. 5,937,698 (FIG. 5) proposes an eccentric rotor, whereby, as the rotor rotates, the mass of the rotor is imbalanced because its center of rotation is offset from the center and so creates a net force in one direction. The present invention maximizes the centripetal force created by the rotation of the rotator with negligible counterforce.

### BRIEF SUMMARY OF THE INVENTION

The primary object of the invention is to provide continuous directional force through its sealed circulating fluid mass.

Another object of the invention is to provide necessary force to move a vehicle so that same vehicle can be used not only on land but also in water, air, and space.

Another object of the invention is to provide vehicle maneuverability in three dimensions by using one or more apparatuses at the same time.

Another object of the invention is to provide circulation of the fluid mass in a loop so that the directional force is created continuously.

A further object of the invention is to reduce the overall weight of a vehicle.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for propulsion comprising: a main body, a fluid flow channel for fluid mass to circulate within a self-sealed apparatus or to the open environment, an air flow channel for air to circulate within a self-sealed apparatus, a fluid mass, a rotator having compartments to move the fluid mass centrifugally, a cover providing sealed containment for the apparatus and providing means to remove the rotator from the main body, and a rotator shaft providing means to rotate the rotator by motor.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is an exploded view of the invention.

FIG. 2 is a plan view of the invention.

FIG. 3 is an isometric view of the invention.

FIG. 4 is an alternate side view of the invention.

FIG. 5 is an alternate isometric view of the invention.

FIG. 6 is an alternate plan view of the invention.

FIG. 7 is an alternate exploded view of the invention.

FIG. 8 is a plan view of two combined apparatuses of the invention.

### DETAILED DESCRIPTION OF THE PREFERRED EMBODIMENTS

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching someone how to employ the present invention in virtually any appropriately detailed system, structure or manner.

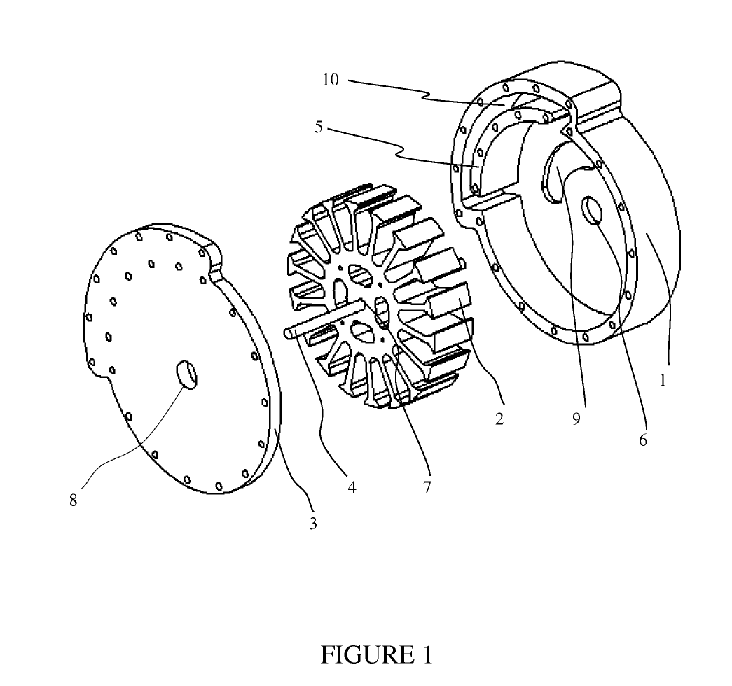

In accordance with the present invention, a propulsion apparatus as shown in FIG. 1, includes a rotational shaft (4) coinciding with the center of the rotator (7) with at least one hole-bearing connection (8) to a cover (3) and at least one hole-bearing connection (6) to a main body (1). The rotational shaft (4) provides linkage between the rotator (2) and the motor via gear or belt or direct connection to the motor.

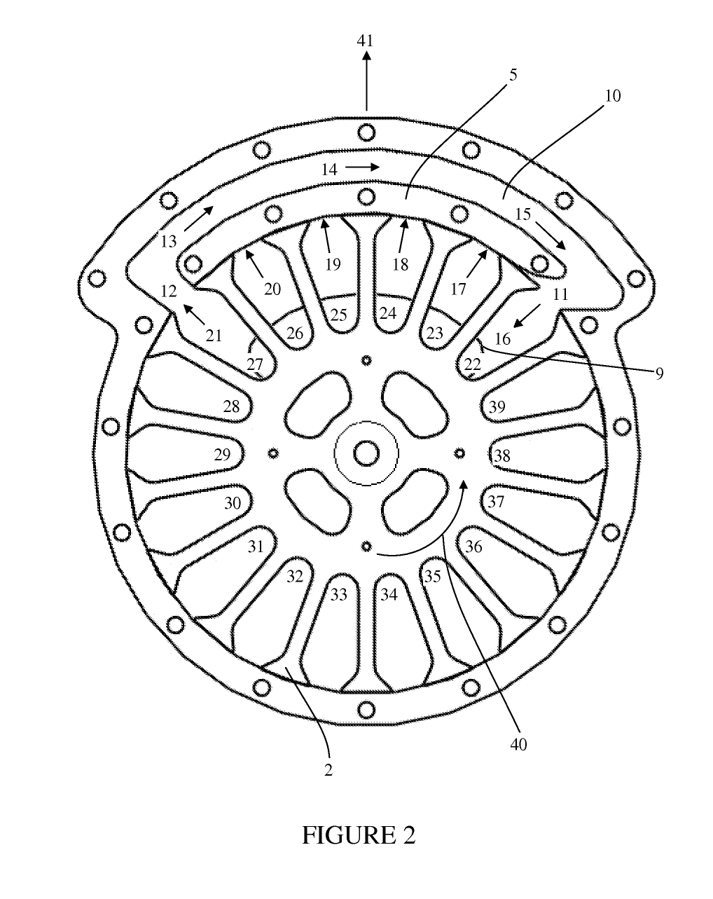

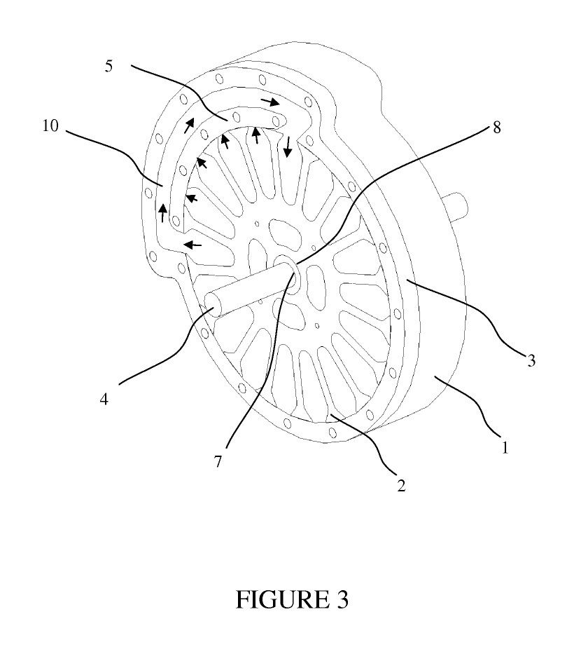

In FIG. 2, the main body further comprising the fluid flow channel (10) provides a mean for fluid mass to circulate between rotator compartments (22 and 27). The air flow channel (9) provides air flow between rotator compartments (22 and 27). A complete assembly of the cover (3), the main body (1), the rotator (2) and the rotational shaft (4) in three dimension view for better understanding is shown in FIG. 3. As fluid mass enters the rotator compartment (22), air has to be pushed out of rotator compartment (22) into air flow channel (9). While at the same time, air has to be sucked into rotator compartment (27) from air flow channel (9) as fluid mass exits the rotator compartment (27). The cover (3) provides the sealed containment for the apparatus and also provides means to install and remove the rotator (2). The main body (1) can be manufactured as one or more parts as demonstrated but not limited to FIG. 1.

As shown in FIG. 2, a fluid flow channel (10) filled with fluid mass. The fluid mass can be any type of liquid, such as water, mercury, oil, or any type of liquid mixed with metallic nano-particles to increase its density. The fluid flow channel (10) has an entry opening (11) and an exit opening (12). The entry opening (11) is for a fluid mass to enter into the rotator compartment (22) of the rotator (2) while air simultaneously exits out rotator compartment (22) through air flow channel (9). The exit opening (12) is for fluid mass to exit the rotator compartment (27) of the rotator (2) while air simultaneously enters into rotator compartment (27) from air flow channel (9) to replace the loss volume of fluid mass flow.

The filled fluid mass in the fluid flow channel (10) enters the rotator compartment (22) through the entry opening (11) while air is being push out of rotator compartment (22) into the air flow channel (9). As the rotator (2) rotates counterclockwise (40), the filled fluid mass in the rotator compartments (23 to 26) pushes against the wall (5) to provide the continuous directional force (17 to 20) required to move the object in the net directional force (41). When the filled fluid mass encounters the exit opening (12), the filled fluid mass will exit the rotator compartment (27) go through an exit opening (12) into fluid flow channel (10) in the fluid flow direction (13 to 15), and the directional force (21) is dissipated. As the fluid mass is exiting the rotator compartment (27), air is being sucked into rotator compartment (27) to replace the loss volume of fluid mass via the air flow channel (9). The rotator compartments (28 to 39) will be empty of fluid mass therefore providing no directional force. The directional force (17 to 20) is transferred from the wall (5) to the main body (1) which then provides a net directional force (41) to the apparatus for propulsion. This net directional force (41) can then be applied by attaching the apparatus for propulsion to a moveable object, more specifically vehicle such as a boat, a car, an airplane, or a spaceship. The circulation of the self-sealed fluid mass within the fluid flow channel (10) and the rotator compartments (22 to 27) by the rotator (2) keeps repeating; and so, the directional force (17 to 20) is continuously produced centrifugally until the rotator (2) stops rotating. To increase or decrease the directional force (17 to 20), the rotator (2) needs to rotate faster or slower, respectively.

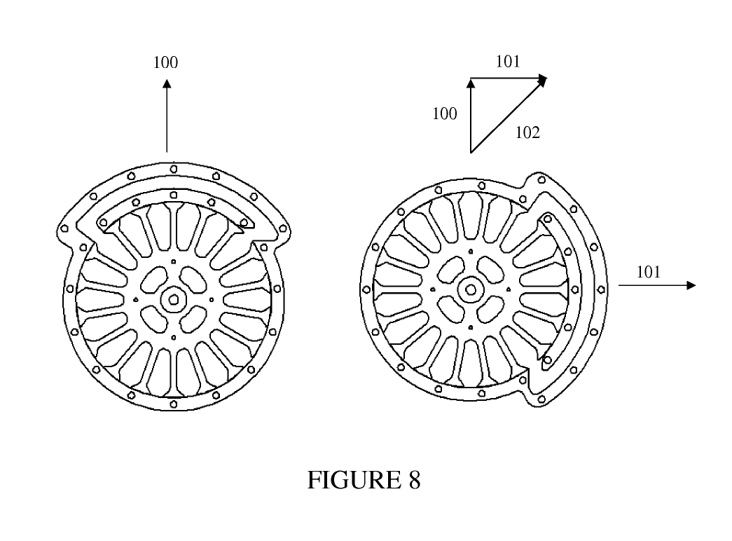

Depending on how an apparatus is mounted to an object, the continuous net directional force (41) can be aligned in such a way that wherever the net directional force (41) is pointing, that is the direction towards which the object will move. If the object needs to move up, the apparatus' net directional force (41) needs to be pointing up. If the object needs to move down, the apparatus' net directional force (41) needs to be pointing down. So as to apply the movement of an object to the right, left, backward, forward and any direction in between, the apparatus' net directional force (41) needs to be pointing in that direction. In addition, a combination of two or more apparatuses can manipulate the direction the object will move by adding individual vector together to provide a resultant vector as FIG. 8 demonstrated. The sum vectors (100 and 101) which are perpendicular to each other and equal in lengths result in a 45 degrees vector (102) that the object will move.

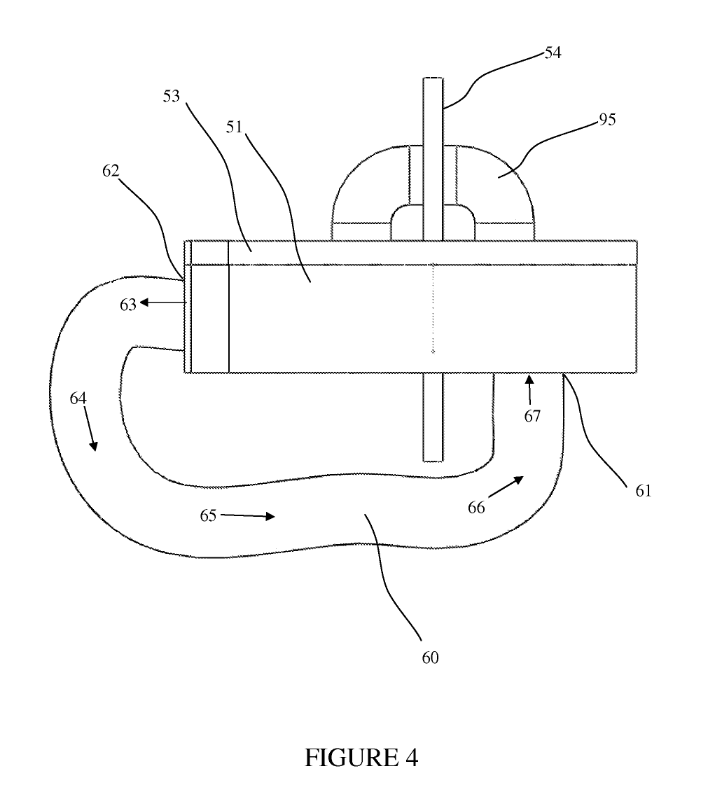

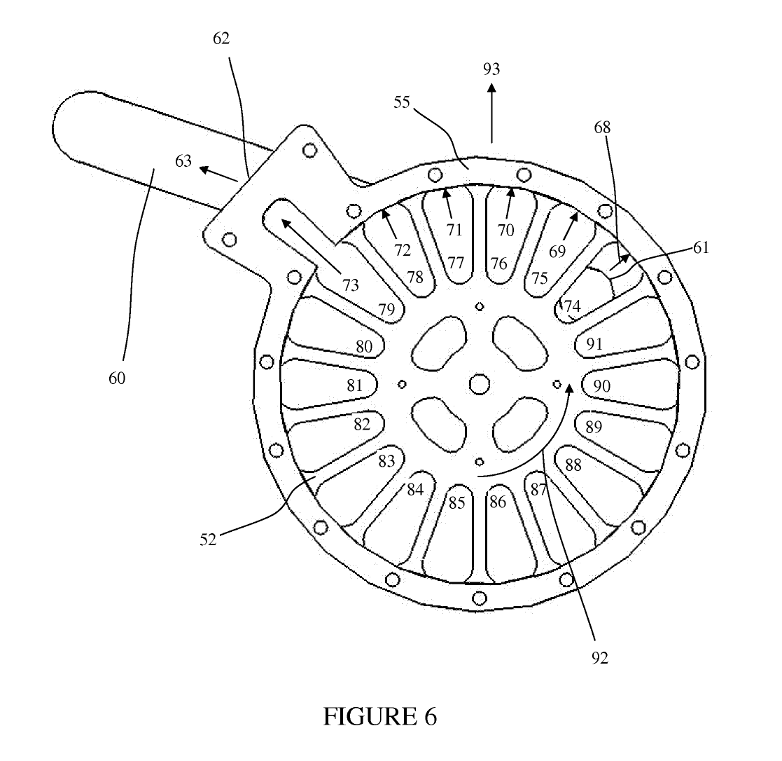

To control and pressurize fluid mass flow further, the said fluid flow channel (10) can be in plane or out of plane at any angle with the main body. FIG. 4 is a demonstration of how the fluid flow channel (10) is now being replaced by channel (60) that has been incorporated out of plane as compared to FIG. 3 in plane. FIG. 6 demonstrates how an entry opening (15) in FIG. 2 is being replaced by an inlet port (61) and exit opening (16) in FIG. 2 is now being replaced by an outlet port (62). In addition, the wall (5) in FIG. 2 is now being replaced by the wall (55) in FIG. 6. The said fluid flow channels (10 and 60) can be combined to provide in-plane and/or out-of-plane channels and can include any numbers, sizes, shapes, and materials that can be machined parts or existing hollow parts such as a pipe or a hose. Furthermore, with the help of a pump or pumps and one or more one-way valves in and/or between the said fluid flow channels (10 in FIGS. 2 and 60 in FIG. 6) and the rotator (2 in FIGS. 2 and 52 in FIG. 6), the fluid mass pressures and the fluid mass flow can be controlled and manipulated.

To further control and pressurize fluid mass flow, the air flow channel (9, 59 and/or 95) can be alter to incorporate a one way valve air pump providing pressurized air to rotator compartment (27 and 79) while providing vacuum to rotator compartment (22 and 74) simultaneously.

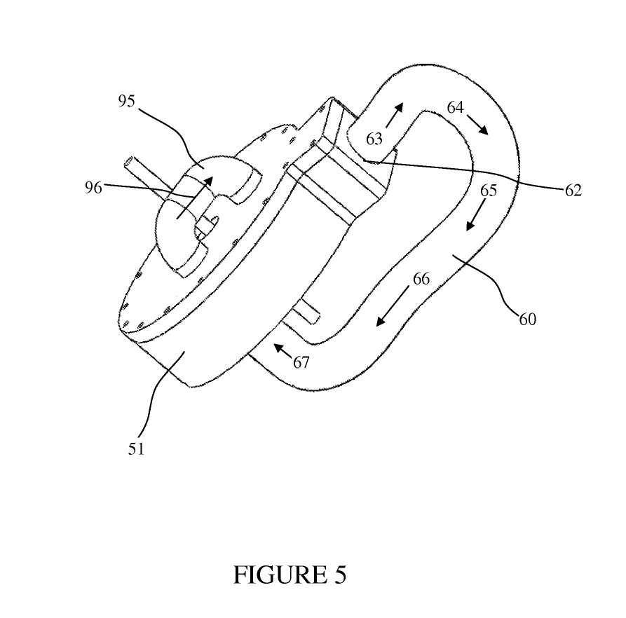

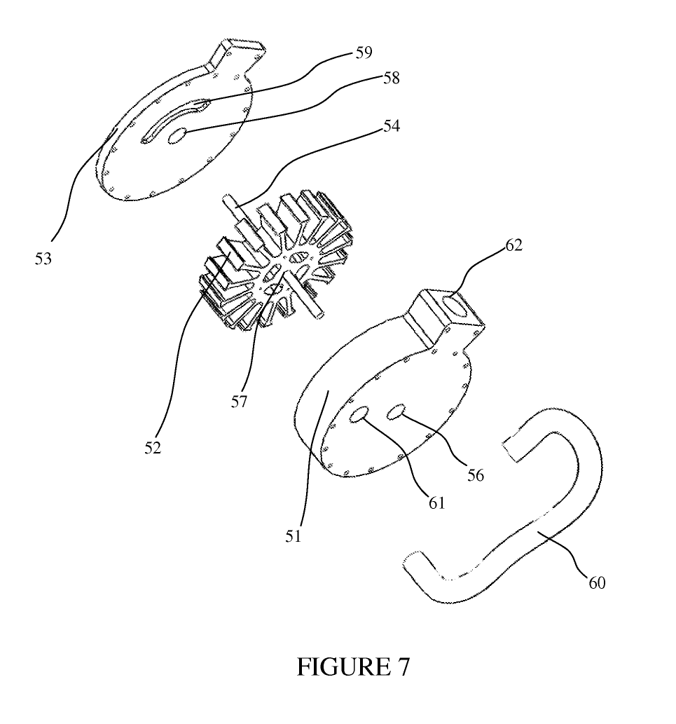

The alternative of the present invention, as demonstrated in FIGS. 4-7, looks different; but the principal of the previous description of how the invention works still applies. Turning to FIG. 6, the channel (60) has an inlet port (61) and an outlet port (62). The inlet port (61) is for a fluid mass to enter into the rotator compartment (74) of the rotator (52). The outlet port (62) is for fluid mass to exit the rotator compartment (79) of the rotator (52). The filled fluid mass in the fluid flow channel (60) enters the rotator compartment (74) through an inlet port (61); while at the same time, air is exiting rotator compartment (74) into the air flow channel (59) and/or (95) in the air flow direction (96). As the rotator rotates counterclockwise (92), the filled fluid mass in the rotator compartments (74 and 78) pushes against the wall (55) to provide a continuous directional force (68 to 72) required to move the object in the net directional force (93). Until the filled fluid mass encounters the outlet port (62), the filled fluid mass will exit the rotator compartment (79), go through an outlet port (62) into the fluid flow channel (60) in the fluid flow direction (63 to 67), and the directional force (73) is dissipated. As the fluid mass is exiting the rotator compartment (79), air is being sucked into rotator compartment (79) to replace the loss volume of fluid mass via the air flow channel (59 and/or 95). The rotator compartments (80 to 91) will be empty of fluid mass therefore providing no directional force. The directional force (68 to 72) is transferred from the wall (55) of the main body (51), which then provides a net directional force (93) to the propulsion apparatus that then can be applied to a moveable object such as a boat, a car, an airplane, or a spaceship. The circulation of the self-sealed fluid mass within the fluid flow channel (60) and the rotator compartments (74 to 79) by the rotator (52) keeps repeating, so that the directional force (68 to 72) is continuously produced centrifugally until the rotator (52) stops rotating.

The numbers, sizes, shapes, and materials of the rotator compartments can vary, depending on the density of the fluid, the laminar flow of the fluid, the fluid control and the desired directional output force that will dictate how big a rotator (2 and 52) is needed to provide the calculated force required to move the vehicle.

In the present form of the invention, comprising gears between the shaft and motor, the torque and speed of the rotator can be controlled, thereby increasing or decreasing the directional output force.

While the invention has been described in connection with a preferred embodiment, it is not intended to limit the scope of the invention to the particular form set forth; but on the contrary, it is intended to cover such alternatives, modifications, and equivalents as may be included within the spirit and scope of the invention as defined by the appended claims.

What is claimed is:

1. An apparatus for propulsion comprising:
a main body;
a fluid mass;
a rotator having compartments to move the fluid mass centrifugally;
a cover providing sealed containment for the apparatus and providing means to remove the rotator from the main body;
a fluid flow channel for fluid mass to circulate within a self-sealed apparatus;
an air flow channel for air to circulate within a self-sealed apparatus or to the open environment.
and a rotator shaft providing a mean for a motor or a gas engine to rotate the rotator;

2. An apparatus for propulsion as claimed in claim 1 wherein the main body and/or cover further comprising:
two or more entry openings and/or an inlet ports for fluid mass flow and air flow;
two or more exit openings and/or an outlet ports ports for fluid mass flow and air flow;
two or more fluid flow channels for fluid mass to circulate within a self-sealed apparatus;
and two or more air flow channels for air flow to circulate within a self-sealed apparatus and/or to the open environment;

3. An apparatus for propulsion as claimed in claim 2 wherein the said entry and exit openings and/or inlet and outlet ports can be:
Made in any numbers, sizes, shapes, and materials;
located in any location on the main body and/or cover to provide a loop back for fluid or air to circulate within the self-sealed apparatus;
and manipulated to control the fluid flow that result in increase or decrease in the net directional force.

4. An apparatus for propulsion as claimed in claim 2 wherein the said air flow channels can be:
made in any numbers, sizes, shapes and materials;
in plane with the main body and cover and/or out of plane with the main body and cover;
located in any location on the main body and/or cover to provide a loop back for air to circulate within the self-sealed apparatus or to the open environment;
incorporated one or more one-way valves in and/or between the air flow channel and the rotator to manipulate and control net directional force;
and incorporated one or more air pumps in and/or between the air flow channel and the rotator to manipulate and control air flow that result in a control and manipulation of net directional force.

5. An apparatus for propulsion as claimed in claim 2 wherein said the fluid flow channel can be:
made in any numbers, sizes, shapes and materials;
in plane with the main body and/or out of plane with the main body;
incorporated one or more one-way valves in and/or between the fluid channel and the rotator to manipulate and control net directional force;
and incorporated one or more fluid pumps in and/or between the fluid channel and the rotator to manipulate and control mass fluid flow that result in a control and manipulation of net directional force.

6. An apparatus for propulsion as claimed in claim 1 wherein said the fluid mass can be:
any type of liquid, such as water, mercury or oil, or any type of liquid mixed with metallic nano-particles;
different in density and/or viscosity in order to control fluid flow and output force.

7. An apparatus for propulsion as claimed in claim 1 wherein the rotator compartments' numbers, sizes, shapes, and materials depend on the density of the fluid, the fluid flow control, and/or the desired directional force.

8. An apparatus for propulsion as claimed in claim 1 wherein it is said to provide continuous directional force through its circulating fluid mass flow and circulating air flow.

9. An apparatus for propulsion as claimed in claim 1 wherein it is said to provide continuous directional force through its circulating fluid mass flow and open to environment air flow.

10. An apparatus for propulsion as claimed in claim 1 wherein it is said to provide necessary force to move a vehicle and to use that same vehicle on land or in water, air, or space.

11. An apparatus for propulsion as claimed in claim 1 wherein it is said to provide vehicle maneuverability in any three dimensions.

12. An apparatus for propulsion as claimed in claim 1 comprising one or more apparatuses to control desired direction.

13. An apparatus for propulsion as claim in claim 1 comprising pump(s) in and/or between the channels used to pressurize and control the fluid mass flow.

14. An apparatus for propulsion as claim in claim 1 comprising air pump(s) in and/or between the channel(s) used to pressurize and control the air flow resulting in the fluid mass flow.

15. An apparatus for propulsion as claimed in claim 1 comprising gears between the shaft and motor to control the torque and speed of the rotator in order to increase and/or decrease the directional output force.

16. An apparatus for propulsion as claimed in claim 1 wherein the main body can be manufactured in one or more parts.

17. An apparatus for propulsion as claimed in claim 1 further comprising a gas engine and/or a motor to provide rotational power directly or through gears or belts to the shaft that coinciding with the rotator.
